(19) United States
(12) Patent Application Publication
(10) Pub. No.: US 2014/0037373 A1
(43) Pub. Date: Feb. 6, 2014

(54) POLE ASSEMBLY

(71) Applicant: Jun Cui, Shenzhen City (CN)

(72) Inventor: Jun Cui, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/593,478

(22) Filed: Aug. 23, 2012

(30) Foreign Application Priority Data
Aug. 6, 2012 (CN) 2012102768505

(51) Int. Cl. F16B 7/10

(52) U.S. Cl. 403/379.5

(57) ABSTRACT

A pole assembly includes a first mounting member defining a locking hole, and a second mounting member setting around the first mounting member. The second mounting member includes a tab operable to be bent into the locking hole to lock the mounting members together.

### BACKGROUND

1. Technical Field

The present disclosure relates to a pole assembly.

2. Description of Related Art

A supporting apparatus for photovoltaic modules may be made by welding a plurality of metal poles together with a non-flexible structure, which results in inconvenience in transportation of the supporting apparatus. Another type of supporting apparatus is assembled by a number of retractable and rotatable poles. The retractable and rotatable poles are connected to each other by screws, which is still inconvenient to assemble the poles.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a pole assembly.

FIG. 2 is an assembled, isometric view of the pole assembly of FIG. 1.

FIG. 3 is a cross-sectional view taken along the line of III-III of FIG. 2.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean “at least one.”

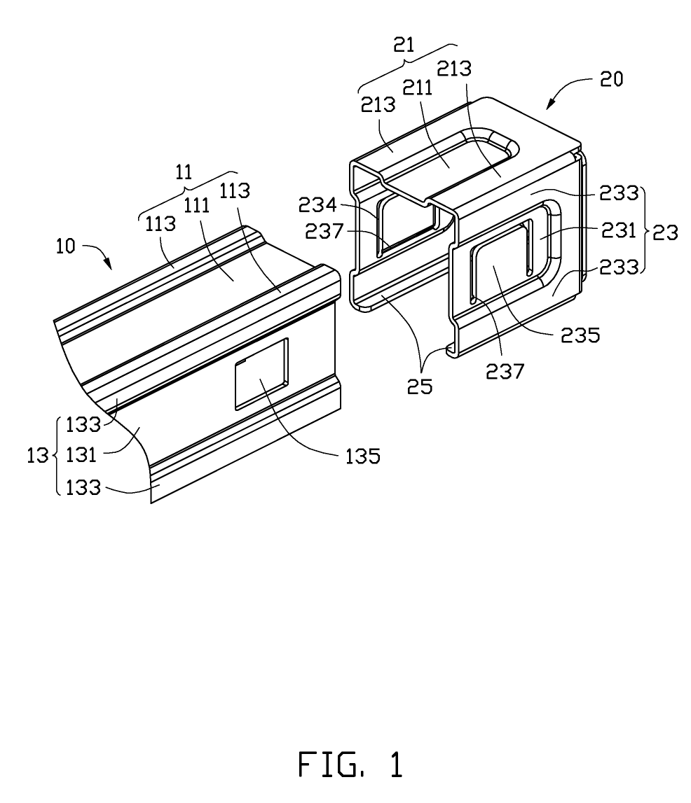

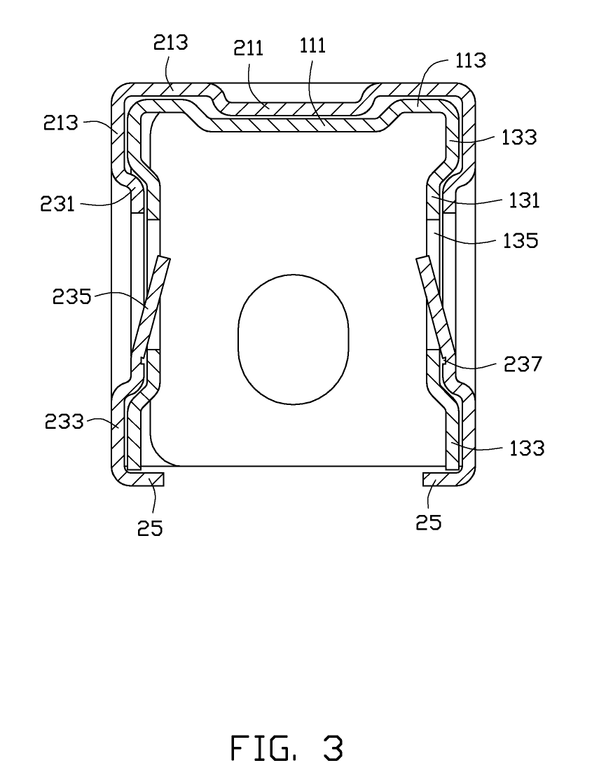

Referring to FIG. 1 and FIG. 3, an embodiment of a pole assembly includes a first mounting member 10 and a second mounting member 20.

The first mounting member 10 includes a middle plate 11 and two side plates 13 extending from opposite sides of the middle plate 11. The middle plate 11 includes a recessed portion 111 and two raised portions 113 extending from opposite sides of the recessed portion 111. Each side plate 13 includes a recessed portion 131 and two raised portions 133 extending from opposite sides of the recessed portion 131. The raised portions 133 adjacent to the middle plate 11 are perpendicularly connected to the raised portions 113. Each recessed portion 131 defines a rectangular locking hole 135.

The second mounting member 20 includes a middle wall 21, two sidewalls 23 extending from opposite sides of the middle wall 21, and two blocking flanges 25 extending towards each other from sides of the sidewalls 23 opposite to the middle wall 21. The middle wall 21 includes a recessed portion 211 and two raised portions 213 extending from opposite sides of the recessed portion 211. Each sidewall 23 includes a recessed portion 231 and two raised portions 233 extending from opposite sides of the recessed portion 231. The raised portions 233 adjacent to the middle wall 21 are perpendicularly connected to the raised portions 213. Each recessed portion 231 defines a U-shaped slot 234. The recessed portion 231 bounded by the slot 234 forms a rectangular tab 235. An elongated notch 237 is defined in a lower portion of an inner surface of each tab 235, facing the other recessed portion 231.

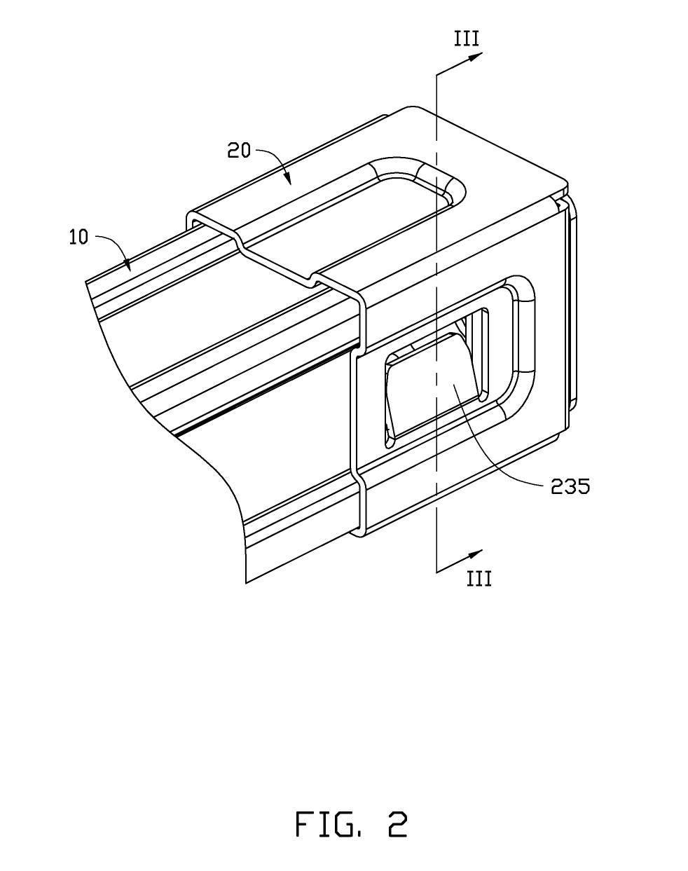

Referring to FIG. 2, in assembly, the second mounting member 20 is set around the first mounting member 10. The middle wall 21 and the sidewalls 23 are in close contact with the middle plate 11 and the side plates 13 respectively. The blocking flanges 25 abut the raised portions 133 opposite to the middle plate 11. The tabs 235 align with the locking holes 135. The tabs 235 are then bent with finger pressure into the locking holes 135 to engage in the locking holes 135. Thus the first mounting member 10 is mounted to the second mounting member 20. The size of the tabs 235 are configured for close mating with the locking holes 135 lengthwise along the second mounting member 20, to prevent lengthwise movement of the second mounting member 20 relative to the first mounting member 10. The notches 237 are used to facilitate the easy bending of the tabs 235.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A pole assembly, comprising:
a first mounting member defining a locking hole; and
a second mounting member setting around the first mounting member, wherein the second mounting member comprises a tab operable to be bent into the locking hole.

2. The pole assembly of claim 1, wherein the first mounting member comprises a middle plate and two side plates extending from opposite sides of the middle plate, the second mounting member comprises a middle wall, two sidewalls extending from opposite sides of the middle wall, the middle wall and the sidewalls are in tight contact with the middle plate and the side plates, respectively.

3. The pole assembly of claim 2, wherein the second mounting member further comprises two blocking flanges respectively extending from sides of the sidewalls opposite to the middle wall, the blocking flanges abut edges of the side plates opposite to the middle plate, respectively.

4. The pole assembly of claim 2, wherein the middle plate comprises a first recessed portion and two first raised portions extending from opposite sides of the first recessed portion, each side plate comprises a second recessed portion and two second raised portions extending from opposite sides of the second recessed portion, the second raised portions adjacent to the middle plate are perpendicularly connected to the first raised portions, respectively.

5. The pole assembly of claim 4, wherein the locking hole is defined in one of the second recessed portions of the side plates.

6. The pole assembly of claim 2, wherein the middle wall comprises a first recessed portion and two first raised portions extending from opposite sides of the first recessed portion, each sidewall comprises a second recessed portion and two second raised portions extending from opposite sides of the second recessed portion, the second raised portions adjacent to the middle wall are perpendicularly connected to the first raised portions, respectively.

7. The pole assembly of claim 6, wherein one of the second recessed portions defines a U-shaped slot to bound the tab.

8. The pole assembly of claim 7, wherein an elongated notch is defined in a lower portion of the tab.
